(19) United States
(12) Patent Application Publication
(10) Pub. No.: US 2006/0182023 A1
(43) Pub. Date: Aug. 17, 2006

(54) Methods and devices for iteratively determining mobile device-to-access point associations to achieve load balancing

(76) Inventors: Yigal Bejerano, Springfield, NJ (US); S. Jamaloddin Golestani, New Providence, NJ (US); Seung-Jae Han, Basking Ridge, NJ (US); Mark Anthony Shawn Smith, Jersey City, NJ (US)

Correspondence Address: HARNESS, DICKEY & PIERCE, P.L.C., P.O. BOX 8910, RESTON, VA, 20195, US

(21) Appl. No.: 11/057,769

(22) Filed: Feb. 15, 2005

(51) Int. Cl. H04Q 7/24; H04Q 7/00; H04L 12/26; H04J 3/14

(52) U.S. Cl. 370/229; 370/328

(57) ABSTRACT

Mobile devices may be associated with access points other than their current access point based on load-balancing objectives of a wireless, local area network during an iterative time period.

### BACKGROUND OF THE INVENTION

Wireless, local area networks (WLANs) are typically comprised of many mobile devices (e.g., wireless laptops, etc.). Each of the mobile devices is associated with a so-called “access point” (AP). The AP acts as a conduit through which messages, information, signaling, etc. may be transferred to, and from, a mobile device. Usually, there are many more mobile devices than APs. For example, it is not uncommon for tens or even hundreds of mobile devices to be associated with the same AP.

At any given point in time, however, one AP may have many mobile devices associated with it while another AP may have far fewer mobile devices associated with it. Comparatively speaking, the first AP may be viewed as being “congested” or overloaded while the latter AP may be viewed as relatively uncongested. Ideally, it is desirable to associate mobile devices with APs in a WLAN such that no single AP is congested. In practice, this is difficult to achieve. Nonetheless, load balancing techniques have been developed which attempt to alleviate congestion in APs to some degree or another.

Though these techniques may reduce congestion in APs, they have the adverse effect of reducing the transmission rate between a mobile device and an AP. That is, an existing technique may alleviate congestion in an AP by associating mobile devices located far from another AP with that AP. In such a case, though an AP's congestion level has been reduced, a mobile device's transmission rate may also be reduced because the mobile device is located so far from its associated AP.

It is, therefore, desirable to provide WLAN load balancing methods and devices that take into consideration the congestion levels and transmission rates of APs and mobile devices, respectively in order to associate a mobile device to an access point.

### A SUMMARY OF SOME EXAMPLES OF THE INVENTION

We have recognized that the load balancing objectives of a WLAN can be met by iteratively determining mobile device-to-access point associations.

In one example of the present invention, a controller is operable to (a) generate a transmission rate ratio from transmission rates derived from transmissions between a mobile device and a currently associated access point (AP) and between the mobile device and another AP during an iterative time period; (b) generate a congestion level ratio from congestion measurements of the APs during the iterative time period; and (c) generate an effectiveness index from the transmission rate and congestion level ratios during the iterative time period.

The so-generated index is a relative indication of the desirability to continue to associate the mobile device with the current AP or to associate the mobile device with the other AP to achieve load balancing objectives of the WLAN during the iterative time period.

### A BRIEF DESCRIPTION OF EXEMPLARY DRAWINGS

FIG. 1 depicts a simplified diagram of a WLAN that includes mobile devices that may be associated with APs while meeting the load balancing objectives of the WLAN in accordance with embodiments of the present invention.

### A DESCRIPTION OF THE INVENTION, INCLUDING EXAMPLES

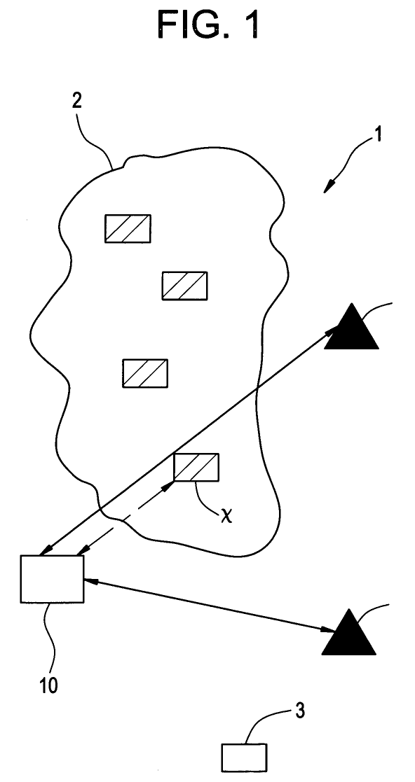

Referring now to FIG. 1, there is shown a WLAN 1 which comprises a plurality of mobile devices 2,3. For illustrative purposes only, a group of mobile devices 2 is currently associated with an access point designated APᵤ while a single mobile device 3 is currently associated with another access point designated as APᵥ. In addition, a mobile device x is shown as part of the group of devices 2. For purposes of the explanation which follows, it can be said that access point APᵤ is congested or overloaded in comparison with access point APᵥ because many more mobile devices are currently associated with access point APᵤ than are associated with access point APᵥ.

Ordinarily, if mobile device x is located closer to access point APᵤ, than to access point APᵥ, the transmission rate between mobile device x and access point APᵤ (abbreviated as R_{x,u}) will be higher than the transmission rate between mobile device x and access point APᵥ (abbreviated as R_{x,v}). This being the case, ordinarily mobile device x would associate itself with access point APᵤ. However, such an association may adversely affect the overall load balancing objectives of the WLAN 1. In addition, it should be noted that although the transmission rate between mobile device x and access point APᵤ may be higher than the transmission rate between mobile device x and access point APᵥ during a given time period, mobile device x may not be able to benefit from this transmission rate advantage even if it is associated with APᵤ because access point APᵤ is congested. Said another way, because access point APᵤ is associated with many mobile devices 2 it may take, relatively speaking, a long period of time before mobile device x is granted the right to send transmissions to, or receive transmissions from, access point APᵤ using its advantageous transmission rate. Instead, mobile device x may have to wait its turn to receive the benefit of the advantageous transmission rate. In contrast, even though the transmission rate between mobile device x and access point APᵥ is lower than the transmission rate between mobile device x and access point APᵤ, mobile device x may be immediately granted the right to send and receive transmissions to and from access point APᵥ because access point APᵥ is less congested than access point APᵤ. Said another way, mobile device x may not have to wait very long to send or receive transmissions to and from access point APᵥ.

In accordance with one embodiment of the present invention, controller 10, which may be part of a network operations center (NOC), is operable to carry out load balancing by controlling the association of one or more mobile devices to an access point after taking into consideration the congestion levels of APᵤ and APᵥ as well as the transmission rates between mobile devices, such as x, and the two access points.

To simplify the explanation of the present invention which follows, the following discussion will initially focus on a single mobile device, x and two access points, APᵤ and APᵥ. However, it should be understood that the present invention is equally applicable to a plurality of mobile devices and more than two access points.

In accordance with one embodiment of the present invention, the controller 10 is operable to receive indicators associated with the transmission rates, R_{x,v}, R_{x,u} from mobile device x during an iterative time period, T, and is thereafter operable to generate a transmission rate ratio, R_{x,v}/R_{x,u}, from the received indicators. Again, it should be recalled that each of the indicators is based upon a transmission rate between the mobile device x and one of the access points APᵤ or APᵥ. In addition to a transmission rate ratio, the controller 10 is further operable to generate a congestion level ratio.

The congestion level ratio is derived from measurements of congestion on both access points APᵤ and APᵥ. Hereafter, to avoid confusion, access point APᵤ may be referred to as a “current” AP while access point APᵥ may be referred to as a “potential”, “other” or “new” AP, the former designation indicating that the mobile device x is currently associated with APᵤ while the latter designations indicating that mobile device x may become associated with access point APᵥ in the future.

The congestion of access points APᵤ and APᵥ may be measured by each of the access points during the iterative time period T, respectively, for example, and then sent to the controller 10.

In yet a further embodiment of the present invention, after generating the transmission rate ratio and congestion level ratio, a controller 10 may be further operable to generate an effectiveness index, I_{x,u,v} from the transmission rate and congestion level ratios.

Before going further, as indicated above the measurements of transmission rates, congestion levels, the generation of an effectiveness index I_{x,u,v} are repeatedly made on an iterative basis, i.e. once during each iteration of T, seconds. In addition, as will be explained below, decisions regarding whether or not to transfer the responsibility of an access point from a current AP to another AP are also carried out on an iterative basis. That is, such functions are carried out during a first, iterative time period (e.g., ten seconds) and then repeated during a next, and each successive time period.

It should be further understood that the designation I_{x,u,v} indicates a particular relationship. In one embodiment of the present invention, this designation (sometimes referred to as a triplet by those skilled in the art) indicates the effectiveness index for a given mobile device x, its current access point APᵤ and another access point APᵥ to which it may potentially be transferred.

Continuing, the effectiveness index, I_{x,u,v}, may be determined using the following equation:
I_{x,u,v}=(R_{x,v}/R_{x,u})[Cᵤ/Cᵥ]^{β} (1)
where the fraction Cᵤ/Cᵥ is the congestion level ratio and the parameter β is an exponent that specifies the relative importance that a network operator and the like may give to the congestion level ratio compared to the transmission rate ratio, R_{x,v}/R_{x,u}. When the parameter β is set equal to 1, the two ratios are given equal importance. However, when the parameter β is set to a value greater than 1, then the congestion level ratio is given a higher importance than the transmission rate ratio, R_{x,v}/R_{x,u}.

In accordance with the present invention, the value of a given index I_{x,u,v} is a relative indication of the desirability to continue to associate a given mobile device x with its currently associated access point, APᵤ, or to associate the mobile device x with another access point, namely, potential access point, APᵥ, during a given iterative time period. Said another way, in general, the index I_{x,u,v} is a relative indication of whether or not a mobile device should remain associated with its current access point or be re-assigned and associated with another access point in order to meet the load balancing objectives of WLAN 1 during a given iterative time period. By taking into consideration both the congestion levels of access points and the transmission rates between access points and a mobile device during a given iterative time period, a mobile device may be associated with a given access point (i.e., either its current access point or a potential access point) without compromising overall network throughput and load balancing objectives of a WLAN.

In yet an additional embodiment of the present invention, the controller 10 may associate mobile device x with the potential access point, APᵥ (i.e., change mobile device x's association from its current access point APᵤ to potential access point APᵥ), when the generated index I_{x,u,v} is equal to or greater than a threshold value, γ during a given iterative time period. That is, a network operator may select a particular threshold value γ for each index I_{x,u,v}.

For example, if the threshold value γ is set to 2, then a mobile device's association may only be changed from its current access point (e.g., APᵤ) to another access point (e.g., APᵥ) if the generated effectiveness index I_{x,u,v} is equal to 2 or more.

It should be understood that the value of the threshold γ is one of design choice and may be varied from WLAN to WLAN or from one iterative time period to another iterative time period. However, generally speaking the value of the threshold γ should be set equal to 1 or more.

Backtracking somewhat, it was mentioned before that the congestion level ratio was based on the congestion levels at access points APᵤ and APᵥ. In an alternative embodiment of the present invention, these congestion levels are based on the congestion experienced by the downlink packet streams for each access point, APᵤ of APᵥ, not uplink streams, during an iterative time period. The rationale for this is that it is fairly easy for an access point to measure downlink delays while it is fairly difficult for an access point to measure uplink delays. For the most part, using downlink delays is a good approximation of an overall delay because most information is transmitted in the downlink direction anyway. In addition, there is a strong positive correlation between the levels of congestion in the uplink and downlink directions. For a given access point, AP_{w}, the designation Dw(t) can be used to indicate such a measured downlink delay.

In addition to the average, downlink delay, the congestion level at each access point also takes into consideration the loss probability of each access point (i.e., the probability that a downlink packet will be dropped by an access point due to congestion). The loss probability for AP_{w} during iteration T can be represented by the value Lw(t).

Again, it should be understood that both Dw(t) and Lw(t) may be measured based on downlink packets handled by an AP during an iterative time period, T.

Combining both Dw(t) and Lw(t), the congestion of a given AP may be represented by the following equation:
Cw(t)=Dw(t)+αLw(t) (2)
where the value α may be used to appropriately adjust the weight (i.e., importance) given to the effects of loss probability, as compared to the effects of delay, in calculating the congestion level of an AP. From Equation (2), Little's formula (known in the art) may be used to further represent the average delay Dw(t) as:
Dw(t)=Qw(t)/Aw(t) (3)
where Aw(t) denotes the average rate of packets arriving at an AP w that will be transmitted on a downlink channel to one or more mobile devices, and Qw(t) is the number of downlink packets present at the queue of AP w, during an iterative time period, T.

So far, the discussion above has mostly centered on a single mobile device x and two access points APᵤ and APᵥ. However, as mentioned above, the present invention is applicable to a plurality of mobile devices and access points. With this in mind, the present invention provides for load balancing methods and devices that make use of a plurality of generated effectiveness indices derived from a plurality of mobile devices and access points where each index is repeatedly recalculated and generated during each iterative time period, T.

During each iterative time period, T, after each of the plurality of indices has been generated, the controller 10 may be operable to determine which of the generated indices equals or exceeds a threshold γ. For each index whose value equals or exceeds the threshold γ, there exists the possibility of transferring or changing a mobile device's association from a current access point to another potential access point (hereinafter sometimes referred to as a “transfer” or “transfers”) during a particular iterative time period, T.

In yet another embodiment of the present invention, once the indices are generated the controller 10 may be operable to create a table of various so-called “transfer candidates” associated with the generated indices, each transfer candidate may be represented as the triplet, x, u, v where, as before, x is a mobile device, u is the access point x is currently associated with and v is an access point to which x may be potentially switched to during some later time period, T.

In accordance with one embodiment of the present invention, the transfer candidates in such a table may be listed in decreasing order, such that those transfer candidates having large indices, I_{x,u,v} are ordered before those with smaller indices.

After creating such an ordered table of indices, the controller 10 may be operable to select a highest index and its associated transfer candidates in order to determine if a transfer is warranted. After making such a decision for the first selected index, the controller 10 is operable to repeatedly select the next highest ranked index and its transfer candidates, etc. The selection of a next index continues until each index in the ranked order has been selected or until another constraint (discussed subsequently) has been met.

Such an ordered table of indices I_{x,u,v} and transfer candidates gives the controller 10 (and thus a network operator) the ability to prioritize transfers; that is, those mobile device-to-access point associations that are most adversely affecting the overall load balancing objectives of a WLAN can be addressed first.

Before the controller 10 may carry out a transfer associated with a selected index and its transfer candidates, however, the present invention may require that the controller 10 satisfy itself that other conditions are present or have been met. That is, during each iterative time period before carrying out a transfer of a mobile device from one access point to another, the controller 10 may be operable to verify that certain other constraints do not prohibit such a transfer.

One such constraint on transfers is used to avoid so-called “congestion oscillations.”

In general, congestion oscillations occur when a load on one access point is shifted to another access point only to result in the congestion of the other access point. Thereafter, in response, the other access point may shift the same load back to the original access point, at which point the original access point may attempt to again shift the load back to the other access point, thus creating a cycle. To prevent such a recurring cycle or oscillation pattern, the present inventors developed additional features which may be used by controller 10 to determine whether a transfer is appropriate after selecting an index during a given iterative time period.

In one embodiment of the present invention, to prevent such oscillations, the present invention provides that the controller 10 may be operable to complete a transfer provided that during the current iterative time period the total number of transfers from the current access point, APᵤ, has not exceeded a first allowable percentage (e.g., 10%) of the load on access point APᵤ and the total number of transfers into the potential access point, APᵥ, has not exceeded a second allowable percentage (e.g., 10%) of the load on access point APᵥ. In an alternative embodiment of the present invention, only if these two provisos are met may a transfer from APᵤ into APᵥ may go forward.

Though the same percentages were used in the examples given above, it should be understood that the percentages may, or may not, be the same.

If, during a given iterative time period, controller 10 determines that either percentage has been exceeded, then the controller 10 may be further operable to cease attempting to make new transfers from access point APᵤ and into access point APᵥ. By so preventing transfers from access point APᵤ and into access point APᵥ, congestion oscillation can be avoided.

It should be noted here, however, that though these provisos affect transfers from access point APᵤ or ones into access point APᵥ, they do not affect transfers into access point APᵤ or from access point APᵥ, i.e., such transfers may still continue.

There are circumstances, however, where AP load considerations may be of less concern than still other, more important concerns. To elaborate further, sometimes a network operator may realize that a particular mobile device is responsible for a large percentage of an access point's load which, under certain circumstances, results in the congestion of the access point. For example, it may occur that mobile device x is responsible for 25% of the load handled by current access point APᵤ during a given iterative time period. If this is so, then it may be next to impossible to ever change the access point that mobile device x is associated with without violating a load constraint, such as the one just described above.

Realizing this, the present invention provides for controllers, such as controller 10, that are operable to allow a mobile device x to change its association from its current access point APᵤ to access point APᵥ provided such a transfer is the first transfer from APᵤ during an iterative time period.

In effect, then, if the controller 10 selects an index and that index indicates a transfer should occur, the controller 10 may be operable to allow such a transfer to proceed during a particular iterative time period regardless of the loads on the current and potential access points involved in the transfer provided such a change represents the very first transfer from the current access point.

In addition to considering the loads on access points and the number of transfers during an iterative time period, T, the present inventors realized that network operators may require that other constraints be placed on transfers.

For example, if an access point, such as access point APᵤ is not congested, then there may be no need to transfer any mobile devices from such an access point. If this occurs, controller 10 may decide not to place the index transfer candidates representing such a situation in a transfer candidate table in the first place; in effect setting this index I_{x,u,v} equal to 0.

Similarly, the present inventors realized that other network operators may wish to only change the AP associations of “active” mobile devices during a given iteration time period, T. For example, a network operator may consider a mobile device to be active when its so-called packet arrival rate during a particular iteration time period is greater than a particular percentage of a total, packet arrival rate at a particular access point, such as access point APᵤ. For example, if the arrival rate associated with mobile device x is equal to or greater than at least 2% of the total arrival rate of packets at access point, APᵤ, then mobile device x may be considered to be an active access point.

Accordingly, taking this into consideration, the present invention provides for controllers, such as controller 10, that may be operable to measure downlink arrival rates during a particular iteration time period, T. This downlink arrival rate is associated with the mobile device x and the current access point APᵤ. If the measured arrival rate is not at least a certain percentage of the total arrival rate of the current access point APᵤ, then controller 10 may be operable to decline to add the transfer candidates associated with such a situation into the table as well.

It should be understood that during a given iteration time period, T, the controller 10 proceeds to select each index, and its associated transfer candidates from the set of qualified indexes (i.e., those that exceed a threshold, γ, in decreasing order, and upon making such a selection proceeds to determine whether a transfer associated with the selected index is appropriate after taking into consideration some or all of the constraints discussed before.

Once the controller 10 has reached the end of a given table (i.e., last set of transfer candidates), no further transfers will be initiated. Instead, whatever transfers (i.e., mobile device-to-access point associations) are indicated will now be used.

At the end of the next iterative time period, the controller 10 may once again build a table of indices and their associated transfer candidates and initiate any indicated transfers.

In yet a further embodiment of the present invention, the iteration time period, T, referred to above may be synonymous with a so-called “run time” period. Using this run-time terminology, one example of how the invention may be carried out is as follows.

During a run time period, the controller 10 may permit a mobile device x to remain associated with a current access point APᵤ. Toward the end of this run time, the controller 10 may be operable to receive indicators of transmission rates and congestion levels from mobile device x, and access points APᵤ and APᵥ, respectively. Before this run time has expired, the controller 10 may be further operable to determine an effectiveness index I_{x,u,v} based on the generated transmission rate and congestion level ratios. In addition, controller 10 may be operable to apply one or more of the constraints discussed above before deciding whether to carry out a transfer. If such a transfer is allowed, at the end of a run time, the controller 10 may be operable to change the AP association of mobile device x from its current access point APᵤ to a new access point APᵥ. Thereafter, the controller 10 may then repeat the process just described.

It should be understood that the functions and features of controller 10, mobile device x, and access points APᵤ and APᵥ may be carried out by software, firmware, hardware or some combination of the three. If software or firmware, one or more programmable memory devices may be used to store one or more programs which in turn may carry out or control the functions and features of the controller 10, mobile device x, and/or access points APᵤ and APᵥ.

The techniques of the present invention may be used in conjunction with one or more additional techniques to actually change the settings within a mobile device, e.g., “forcing” a mobile device to become associated with a particular access point, as dictated by load balancing objectives, not just signal-to-noise objectives. One such technique is disclosed in co-pending U.S. patent application Ser. No. ______, the disclosure of which is incorporated herein as if set forth in full herein.

The discussion above has set forth a brief description of the present invention using some examples. It should be understood, however, that the true scope of the present invention is determined by the claims which follow.

1. A method for iteratively determining a mobile device-to-access point association in a wireless, local area network (WLAN) to achieve load balancing, comprising the steps of:
(a) generating a transmission rate ratio from transmission rates derived from transmissions between a mobile device and a currently associated access point (AP) and between the mobile device and another AP during an iterative time period;
(b) generating a congestion level ratio from congestion measurements of the APs during the iterative time period;
(c) generating an effectiveness index from the transmission rate and congestion level ratios during the iterative time period,
wherein the index is a relative indication of the desirability to continue to associate the mobile device with the current AP or to associate the mobile device with the other AP to achieve load balancing objectives of the WLAN during the iterative time period.

2. The method as in claim 1 further comprising the steps of:
repeating steps (a) through (c) for each of a plurality of mobile devices and each device's current AP and another AP during an iterative time period;
determining which values of the generated indices equals or exceeds a threshold during the iterative time period; and
organizing each index, whose value equals or exceeds the threshold, into a ranked grouping of indices in descending order from a highest index value to a lowest index value during the iterative time period.

3. The method as in claim 2 further comprising the steps of:
selecting a highest remaining index value; and
associating a mobile device indicated by the selected index with an AP other than its current AP during the iterative time period.

4. The method as in claim 1 further comprising the step of associating the mobile device with the other AP when the index is equal to, or greater than, a threshold value during the iterative time period.

5. The method as in claim 2 further comprising the steps of:
monitoring a number of transfers from a current AP during an iterative time period;
monitoring a number of transfers to another AP during the iterative time period; and
associating a mobile device with the other AP when the index is equal to, or greater than, a threshold value provided the number of transfers from the current AP has not exceeded a first allowable percentage during the iterative time period and provided the number of transfers to the other AP has not exceeded a second allowable percentage during the iterative time period.

6. The method as in claim 5 wherein the first and second allowable percentages are the same.

7. The method as in claim 6 wherein the first and second allowable percentages are equal to 10%.

8. The method as in claim 2 further comprising the steps of:
associating the mobile device with another AP if such an association is the first such association from the current AP during the iterative time period provided the index is equal to, or greater than, a threshold value.

9. The method as in claim 2 further comprising the step of:
declining to associate a mobile device with another AP when a current AP is not congested during an iterative time period.

10. The method as in claim 2 further comprising the steps of:
measuring a downlink arrival rate associated with a mobile device and a current AP when the index is equal to, or greater than, the threshold during an iterative time period;
associating the mobile device with another AP provided the measured arrival rate is at least a minimum percentage of a total arrival rate at the current AP during the iterative time period; and
declining to associate the mobile device with the other AP when the measured arrival rate is less than the minimum percentage of the total arrival rate during the iterative time period.

11. The method as in claim 10 wherein the minimum percentage is at least 2%.

12. The method as in claim 1 wherein the iterative time period is a run-time.

13. A device, for iteratively determining mobile device-to-access point associations in a wireless, local area network (WLAN) to achieve load balancing, operable to:
(a) generate a transmission rate ratio from transmission rates derived from transmissions between a mobile device and a currently associated access point (AP) and between the mobile device and another AP during an iterative time period;
(b) generate a congestion level ratio from congestion measurements of the APs during the iterative time period;
(c) generate an effectiveness index from the transmission rate and congestion level ratios during the iterative time period,
wherein the index is a relative indication of the desirability to continue to associate the mobile device with the current AP or to associate the mobile device with the other AP to achieve load balancing objectives of the WLAN during the iterative time period.

14. The device as in claim 13 further operable to:
repeat steps (a) through (c) for each of a plurality of mobile devices and each device's current AP and another AP during an iterative time period;
determine which values of the generated indices equals or exceeds a threshold during the iterative time period; and
organize each index, whose value equals or exceeds the threshold, into a ranked grouping of indices in descending order from a highest index value to a lowest index value during the iterative time period.

15. The device as in claim 14 further operable to:
select a highest remaining index value; and
associate a mobile device indicated by the selected index with an AP other than its current AP during the iterative time period.

16. The device as in claim 13 further operable to associate the mobile device with the other AP when the index is equal to, or greater than, a threshold value during the iterative time period.

17. The device as in claim 14 further operable to:
monitor a number of transfers from a current AP during an iterative time period;
monitor a number of transfers to another AP during the iterative time period; and
associate a mobile device with another AP when the index is equal to, or greater than, a threshold value provided the number of transfers from the current AP has not exceeded a first allowable percentage and provided the number of transfers to the other AP has not exceeded a second allowable percentage during the iterative time period.

18. The device as in claim 17 wherein the first and second allowable percentages are the same.

19. The device as in claim 18 wherein the first and second allowable percentages are equal to 10%.

20. The device as in claim 14 further operable to:
associate the mobile device with another AP if such an association is the first such association from the current AP during the iterative time period provided the index is equal to, or greater than, a threshold value.

21. The device as in claim 14 further operable to:
decline to associate a mobile device with another AP when a current AP is not congested during an iterative time period.

22. The device as in claim 14 further operable to:
measure a downlink arrival rate associated with a mobile device and a current AP when the index is equal to, or greater than, the threshold during an iterative time period;
associate the mobile device with another AP provided the measured arrival rate is at least a minimum percentage of a total arrival rate at the current AP during the iterative time period; and
decline to associate the mobile device with the other AP when the measured arrival rate is less than minimum percentage of the total arrival rate during the iterative time period.

23. The device as in claim 22 wherein the minimum percentage is at least 2%.

24. The device as in claim 13 wherein the device comprises a controller.

25. The device as in claim 13 wherein the iterative time period is a run-time.

26. A method for determining whether to transfer a mobile device from a current access point to another access point comprising the steps of:
(a) generating a transmission rate ratio from transmission rates derived from transmissions between a mobile device and a currently associated access point (AP) and between the mobile device and another AP during an iterative time period;
(b) generating a congestion level ratio from congestion measurements of the APs during the iterative time period;
(c) generating an effectiveness index from the transmission rate and congestion level ratios during the iterative time period;
(d) determining whether the generated index equals or exceeds a threshold during the iterative time period; and
(e) associating the mobile device with the other AP during the iterative time period provided the index equals or exceeds the threshold and such a transfer satisfies transfer constraints.

27. A device for determining whether to transfer a mobile device from a current access point to another access point operable to:
(a) generate a transmission rate ratio from transmission rates derived from transmissions between a mobile device and a currently associated access point (AP) and between the mobile device and another AP during an iterative time period;
(b) generate a congestion level ratio from congestion measurements of the APs during the iterative time period;
(c) generate an effectiveness index from the transmission rate and congestion level ratios during the iterative time period;
(d) determine whether the generated index equals or exceeds a threshold during the iterative time period; and
(e) associate the mobile device with the other AP during the iterative time period provided the index equals or exceeds the threshold and such a transfer satisfies transfer constraints.
